(19) United States
(12) Patent Application Publication
(10) Pub. No.: US 2020/0081856 A1
(43) Pub. Date: Mar. 12, 2020

(54) INTERFACE DEVICE

(71) Applicant: Mitsubishi Electric Corporation, Tokyo (JP)

(72) Inventor: Yoshihisa KOJIMA, Tokyo (JP)

(21) Appl. No.: 16/466,359

(22) PCT Filed: Jan. 12, 2017
(86) PCT No.: PCT/JP2017/000822

§ 371 Date: Jun. 4, 2019

(51) Int. Cl. G06F 13/38; F24F 11/30; H04L 12/28

(52) U.S. Cl. CPC G06F 13/385; H04L 12/28; F24F 11/30

(57) ABSTRACT

An interface device includes: an air conditioner communication unit that transmits and receives information in a format conforming to a communication protocol of an air conditioner to and from the air conditioner; a home automation communication unit that transmits and receives information in a format conforming to an ANSI/CEA-2045 standard to and from a communication module; and a conversion unit that converts the information in the format conforming to the communication protocol of the air conditioner into information in the format conforming to the ANSI/CEA-2045 standard, and converts the information that is received by the home automation communication unit and is in the format conforming to the ANSI/CEA-2045 standard into information in the format conforming to the communication protocol of the air conditioner.

### CROSS REFERENCE TO RELATED APPLICATION

This application is a U.S. national stage application of International Patent Application No. PCT/JP2017/000822 filed on Jan. 12, 2017, the disclosure of which is incorporated herein by reference.

### TECHNICAL FIELD

The present invention relates to an interface device that can connect a household appliance to a network.

### BACKGROUND

The Consumer Electronics Association (CEA) has recently formulated the American National Standard Institute (ANSI)/CEA-2045 standard as a communication standard for controlling household appliances, and it is becoming more popular to control household appliances in accordance with the ANSI/CEA-2045 standard (see Patent Literature 1, for example). When a household appliance compliant with the ANSI/CEA-2045 standard is connected to a network, the household appliance compliant with the ANSI/CEA-2045 standard can be controlled from an operation terminal such as a smartphone via the network.

The household appliance compliant with the ANSI/CEA-2045 standard has a socket, and a communication module called a universal communication module (UCM) is connected to the socket. This allows the household appliance compliant with the ANSI/CEA-2045 standard to be connected to the network.

### PATENT LITERATURE

Patent Literature 1: Japanese Patent Application Laid-open No. 2015-119389

However, in a case where a user owns a household appliance not compliant with the ANSI/CEA-2045 standard, the household appliance not compliant with the ANSI/CEA-2045 standard cannot be connected to a network. In order for the appliance to be connected to a network, the user needs to replace the household appliance that he owns with a household appliance compliant with the ANSI/CEA-2045 standard, which is a burden to the user.

### SUMMARY

The present invention has been made in view of the above, and an object of the present invention is to provide an interface device that allows a household appliance not compliant with the ANSI/CEA-2045 standard to be connected to a network.

An interface device according to an aspect of the present invention is connected to a device not compliant with a communication standard and to a communication module connected to a network. The interface device includes a first communication unit that transmits and receives information in a format conforming to a communication protocol used among a plurality of the devices, to and from the device. The interface device includes a second communication unit that transmits and receives information in a format conforming to the communication standard to and from the communication module. The interface device includes a conversion unit that converts the information from the device that is received by the first communication unit and is in the format conforming to the communication protocol used among the plurality of the devices into information in the format conforming to the communication standard, and converts the information that is received by the second communication unit and is in the format conforming to the communication standard into information in the format conforming to the communication protocol used among the plurality of the devices.

The interface device according to the present invention has an effect of allowing a household appliance not compliant with the ANSI/CEA-2045 standard to be connected to a network.

### BRIEF DESCRIPTION OF DRAWINGS

FIG. 1 is a diagram for explaining an example of a home network including an interface device according to a first embodiment of the present invention.

FIG. 2 is a diagram illustrating an example of the functional configuration of the interface device in FIG. 1.

FIG. 3 is a diagram for explaining the configuration of a database in FIG. 2.

FIG. 4 is a diagram illustrating a control circuit of the interface device in FIG. 1.

FIG. 5 is a sequence diagram for explaining information conversion process that is executed by the interface device in FIG. 1.

FIG. 6 is a sequence diagram for explaining the information conversion process that is executed by the interface device in FIG. 1.

FIG. 7 is a diagram for explaining conversion of information performed by the interface device in the first embodiment.

FIG. 8 is a diagram illustrating an example of the functional configuration of an interface device according to a second embodiment of the present invention.

FIG. 9 is a diagram illustrating an example of the functional configuration of an interface device according to a third embodiment of the present invention.

FIG. 10 is a flowchart of cooling/heating switch process that is executed by a cooling/heating switch management unit of the interface device in FIG. 9.

FIG. 11 is a flowchart of the cooling/heating switch process that is executed by the cooling/heating switch management unit of the interface device in FIG. 9.

FIG. 12 is a flowchart of the cooling/heating switch process that is executed by the cooling/heating switch management unit of the interface device in FIG. 9.

FIG. 13 is a flowchart of the cooling/heating switch process that is executed by the cooling/heating switch management unit of the interface device in FIG. 9.

FIG. 14 is a diagram for explaining an example of information on a set temperature of an air conditioner transmitted from a home automation server in the third embodiment.

FIG. 15 is a diagram for explaining cooling/heating switch control performed by the interface device in the third embodiment.

FIG. 16 is a diagram for explaining energy saving control and the cooling/heating switch control performed by the interface device in the third embodiment.

### DETAILED DESCRIPTION

An interface device according to embodiments of the present invention will now be described in detail with reference to the drawings. Note that the present invention is not limited to the embodiments.

### First Embodiment

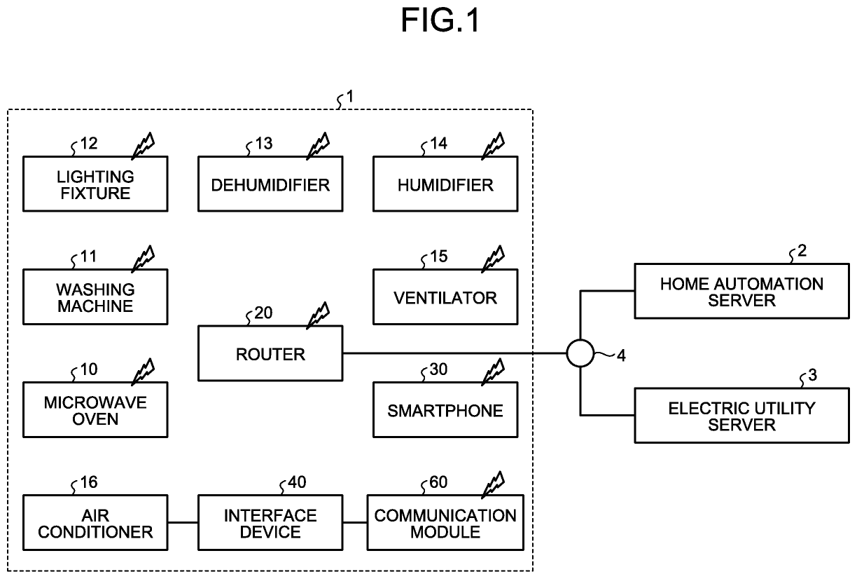

First, a home network including an interface device according to a first embodiment of the present invention will be described. FIG. 1 is a diagram for explaining an example of a home network including an interface device according to the first embodiment of the present invention.

As illustrated in FIG. 1, a home network 1 includes a microwave oven 10, a washing machine 11, a lighting fixture 12, a dehumidifier 13, a humidifier 14, a ventilator 15, an air conditioner 16, a router 20, a smartphone 30, an interface device 40, and a communication module 60 that is called a universal communication module (UCM). The microwave oven 10, the washing machine 11, the lighting fixture 12, the dehumidifier 13, the humidifier 14, the ventilator 15, and the air conditioner 16 are examples of household appliances. Hereinafter, the microwave oven 10, the washing machine 11, the lighting fixture 12, the dehumidifier 13, the humidifier 14, and the ventilator 15 are referred to as household appliances 10 to 15. The household appliances 10 to 15 and the air conditioner 16 may be referred to as household appliances 10 to 16 in some cases. The ANSI/CEA-2045 standard is an example of a communication standard. The household appliances 10 to 15, the smartphone 30, and the communication module 60 making up the home network 1 can be connected to the Internet 4 via the router 20. The household appliances 10 to 15, the smartphone 30, and the communication module 60 can be connected to a home automation server 2 via the router 20 and the Internet 4. The home automation server 2 can be connected to the household appliances 10 to 15, the smartphone 30, and the communication module 60 via the Internet 4 and the router 20. An electric utility server 3 can be connected to the home automation server 2 via the Internet 4.

The household appliances 10 to 15 are compliant with the ANSI/CEA-2045 standard. The household appliances 10 to 15 each have a socket to which a communication module called the UCM is connected, and can be connected to the router 20 by connecting the communication module called the UCM to the socket. This allows the household appliances 10 to 15 compliant with the ANSI/CEA-2045 standard to be connected to the home network 1.

The air conditioner 16 is a household appliance not compliant with the ANSI/CEA-2045 standard and thus cannot be connected to the router 20 conventionally. In the present embodiment, the interface device 40 executes information conversion process to be described later. As a result, in the present embodiment, the air conditioner 16 included in the home network 1 can be connected to the router 20 via the interface device 40 and the communication module 60.

In the present embodiment, a user can operate and monitor the air conditioner 16 by using an application installed on the smartphone 30. When wishing to perform a change operation of a set temperature of the air conditioner 16, for example, the user enters a changed value for the set temperature of the air conditioner 16 using the application. The information on the operation of the change entered by the user using the application is temporarily stored in the home automation server 2. The communication module 60 periodically polls the home automation server 2 and, when finding that the information on the change operation is stored in the home automation server 2, receives the information on the change operation. The communication module 60 transmits the information on the change operation being received to the interface device 40. The interface device 40 transmits the information on the change operation to the air conditioner 16 after executing the information conversion process to be described later. Upon receiving the information on the change operation, the air conditioner 16 changes the set temperature of the air conditioner 16 and performs air conditioning control. When the communication module 60 and the smartphone 30 are connected to the same router 20, the communication module 60 may directly receive the information on the change operation from the smartphone 30 without going through the home automation server 2.

In the present embodiment, the electric utility server 3 manages a current power usage within an area including the home network 1 which the server takes charge of. When a power shortage is likely to occur within the area which the electric utility server 3 takes charge of, the electric utility server 3 can transmit a command for energy saving control in the home network 1 to the home automation server 2. The energy saving control refers to control for reducing the power consumption of the household appliances 10 to 16. When receiving the command for the energy saving control, the home automation server 2 can transmit the command, to the communication modules including the communication module 60 connected to the household appliances 10 to 16 via the Internet 4 and the router 20. Upon receiving the command for the energy saving control, the communication modules including the communication module 60 can transmit the command to the household appliances 10 to 16. Details of the energy saving control on the household appliances 10 to 16 can be preset by the user using an application installed on the smartphone 30, for example. When the air conditioner 16 is to be subjected to the energy saving control, for example, the interface device 40 transmits a command for shifting the set temperature of the air conditioner 16 by an amount preset by the user to the air conditioner 16 on the basis of the command for the energy saving control received by the communication module 60.

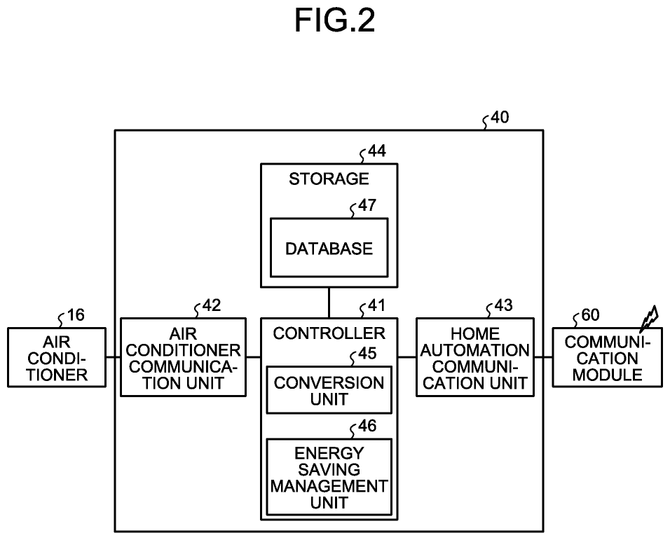

Next, the functional configuration of the interface device 40 in FIG. 1 will be described. FIG. 2 is a diagram illustrating an example of the functional configuration of the interface device 40 in FIG. 1.

As illustrated in FIG. 2, the interface device 40 includes a controller 41, an air conditioner communication unit 42, a home automation communication unit 43, and a storage 44. The air conditioner communication unit 42 is an example of a first communication unit. The home automation communication unit 43 is an example of a second communication unit.

The controller 41 controls the overall operation of the interface device 40. The controller 41 includes a conversion unit 45 and an energy saving management unit 46. The conversion unit 45 converts information that is transmitted from the air conditioner 16 and is in a format conforming to a communication protocol of the air conditioner 16 into information in a format conforming to the ANSI/CEA-2045 standard. The conversion unit 45 converts information that is transmitted from the communication module 60 and is in the format conforming to the ANSI/CEA-2045 standard into information in the format conforming to the communication protocol of the air conditioner 16. The energy saving management unit 46 manages the energy saving control of the air conditioner 16. The energy saving management unit 46 calculates a value of the set temperature of the air conditioner 16 at the time of the energy saving control by using a user-set value (to be described) stored in the storage 44 and a value of the set temperature of the air conditioner 16 accumulated in a database 47.

The air conditioner communication unit 42 transmits and receives information in the format conforming to the communication protocol of the air conditioner 16 to and from the air conditioner 16. The home automation communication unit 43 transmits and receives information in the format conforming to the ANSI/CEA-2045 standard to and from the communication module 60.

The storage 44 stores the user-set value indicating how much the value of the set temperature of the air conditioner 16 is shifted at the time of the energy saving control. The storage 44 includes the database 47. The database 47 accumulates the information that is received by the air conditioner communication unit 42 and is in the format conforming to the communication protocol of the air conditioner 16. The database 47 accumulates the information that is received by the home automation communication unit 43 and is in the format conforming to the ANSI/CEA-2045 standard. The database 47 accumulates the information in the format conforming to the ANSI/CEA-2045 standard corresponding to the information in the format conforming to the communication protocol of the air conditioner 16, and also the information in the format conforming to the communication protocol of the air conditioner 16 corresponding to the information in the format conforming to the ANSI/CEA-2045 standard.

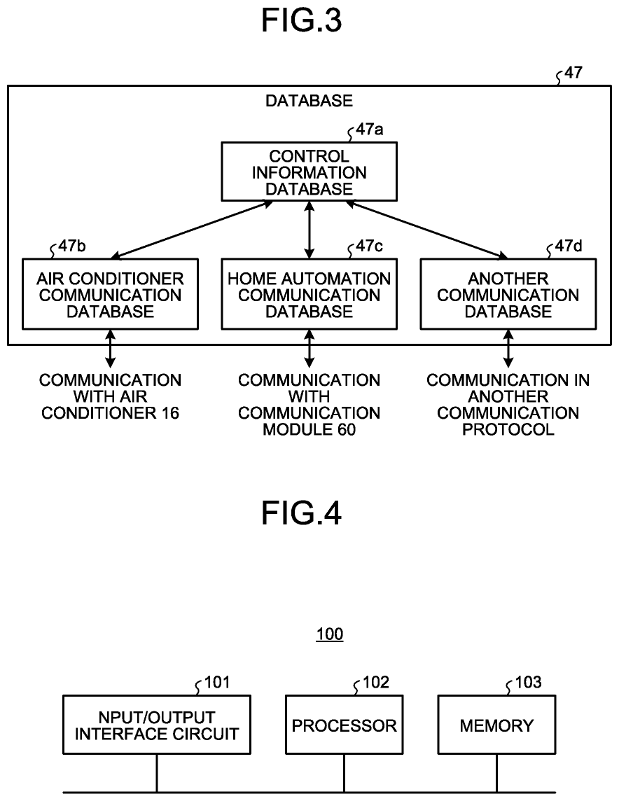

Next, the configuration of the database 47 in FIG. 2 will be described. FIG. 3 is a diagram for explaining the configuration of the database 47 in FIG. 2.

As illustrated in FIG. 3, the database 47 includes a control information database 47a, an air conditioner communication database 47b, and a home automation communication database 47c.

The air conditioner communication database 47b converts information that is transmitted from the air conditioner 16 and is in the format conforming to the communication protocol of the air conditioner 16 into information in a format that can be saved in the control information database 47a. The information in the format that can be saved in the control information database 47a, which is obtained after the conversion by the air conditioner communication database 47b is saved, in the control information database 47a. The home automation communication database 47c converts information that is transmitted from the communication module 60 and is in the format conforming to the ANSI/CEA-2045 standard into information in the format that can be saved in the control information database 47a. The information in the format that can be saved in the control information database 47a that is obtained after the conversion by the home automation communication database 47c, is saved in the control information database 47a.

The control information database 47a loads information a state on which has changed, that is, the information saved in the control information database 47a, into the air conditioner communication database 47b and the home automation communication database 47c. The control information database 47a may load the information saved in the control information database 47a into the air conditioner communication database 47b and the home automation communication database 47c when, for example, a request for transmission of the information is made from the controller 41.

The air conditioner communication database 47b converts the information loaded from the control information database 47a into information in the format conforming to the communication protocol of the air conditioner 16. The home automation communication database 47c converts the information loaded from the control information database 47a into information in the format conforming to the ANSI/CEA-2045 standard.

In the present embodiment, the information transmitted from the air conditioner 16 is transmitted to the communication module 60 via the control information database 47a. The information transmitted from the communication module 60 is transmitted to the air conditioner 16 via the control information database 47a. The information is transmitted via the control information database 47a in order for the control information database 47a to have a function as a common database and for the database 47 to have extensibility. Therefore, another communication database 47d can be added to the database 47 as illustrated in FIG. 3. The another communication database 47d can be removed from the database 47. The other communication database 47d converts information in a format conforming to another communication protocol into information in the format that can be saved in the control information database 47a, and also converts information loaded from the control information database 47a into information in the format conforming to the other communication protocol.

Next, the hardware configuration of the interface device 40 in FIG. 1 will be described. FIG. 4 is a diagram illustrating a control circuit 100 of the interface device 40 in FIG. 1. The interface device 40 includes the control circuit 100 that is hardware implementing the controller 41, a part of the air conditioner communication unit 42, a part of the home automation communication unit 43, and a part of the storage 44. The hardware implementing the functional unit of the interface device 40 in FIG. 1 may be a dedicated process circuit.

The control circuit 100 includes an input/output interface circuit 101 including an input circuit to which information from the outside of the control circuit 100 is input and an output circuit which outputs information to the outside of the control circuit 100, a processor 102, and a memory 103. The input/output interface circuit 101 transmits information received from outside to the memory 103. The memory 103 stores the information received from the input/output interface circuit 101. A computer program is stored in the memory 103. The processor 102 reads the computer program stored in the memory 103 and performs arithmetic process on the basis of the information stored in the memory 103. Arithmetic result information indicating a result of the arithmetic process by the processor 102 is transmitted to the memory 103. The input/output interface circuit 101 transmits the information stored in the memory 103 to the outside.

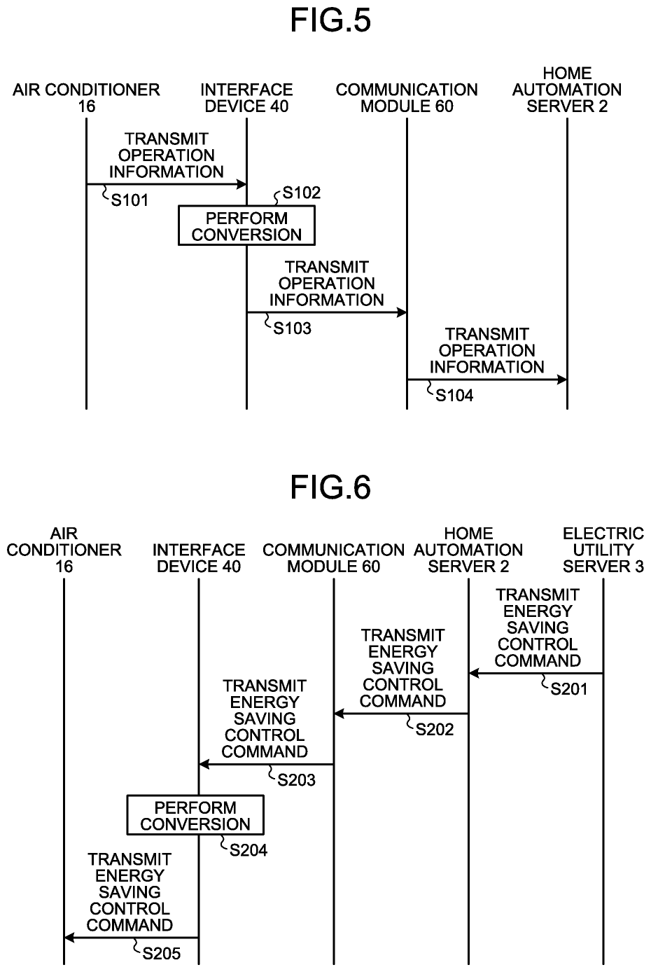

Next, the information conversion process executed by the interface device 40 in FIG. 1 will be described. FIGS. 5 and 6 are sequence diagrams for explaining the information conversion process executed by the interface device 40 in FIG. 1. In FIG. 5, the interface device 40 converts operation information on the air conditioner 16 that is transmitted from the air conditioner 16 and is in the format conforming to the communication protocol of the air conditioner 16 into operation information on the air conditioner 16 in the format conforming to the ANSI/CEA-2045 standard. The operation information on the air conditioner 16 is information indicating an operating status of the air conditioner 16 such as information that an operating mode of the air conditioner 16 is set to cooling. The operation information on the air conditioner 16 in the format conforming to the communication protocol of the air conditioner 16 is an example of information in a format conforming to a communication protocol used between devices. The operation information on the air conditioner 16 in the format conforming to the ANSI/CEA-2045 standard is an example of information in a format conforming to a communication standard. In FIG. 6, the interface device 40 converts a command for the energy saving control that is transmitted from the home automation server 2 and is in the format conforming to the ANSI/CEA-2045 standard into a command for the energy saving control in the format conforming to the communication protocol of the air conditioner 16. The command for the energy saving control in the format conforming to the ANSI/CEA-2045 standard is an example of information in the format conforming to a communication standard. The command for the energy saving control in the format conforming to the communication protocol of the air conditioner 16 is an example of information in the format conforming to a communication protocol used between devices.

In FIG. 5, the air conditioner 16 first transmits the operation information on the air conditioner 16 in the format conforming to the communication protocol of the air conditioner 16 to the interface device 40, and the air conditioner communication unit 42 of the interface device 40 receives the operation information on the air conditioner 16 being transmitted (step S101).

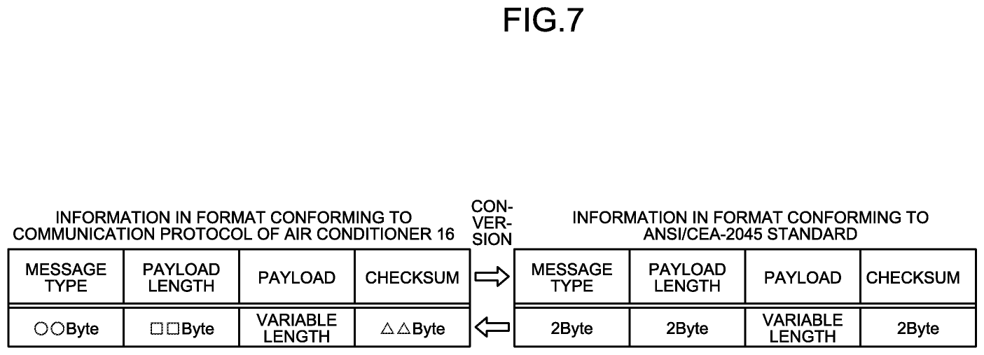

Next, the conversion unit 45 of the interface device 40 converts the operation information on the air conditioner 16 received by the air conditioner communication unit 42 in step S101 into the operation information on the air conditioner 16 in the format conforming to the ANSI/CEA-2045 standard (step S102). In step S102, the conversion unit 45 of the interface device 40 accumulates the operation information on the air conditioner 16 received by the air conditioner communication unit 42 in step S101 into the database 47. In step S102, as illustrated in FIG. 7, the conversion unit uses the database 47 to convert the operation information on the air conditioner 16 in the format conforming to the communication protocol of the air conditioner 16 into the operation information on the air conditioner 16 in the format conforming to the ANSI/CEA-2045 standard.

Next, the home automation communication unit 43 of the interface device 40 transmits the operation information on the air conditioner 16 in the format conforming to the ANSI/CEA-2045 standard as obtained by the conversion in step S102 to the communication module 60, and the communication module 60 receives the operation information on the air conditioner 16 being transmitted (step S103).

Next, the communication module 60 converts the operation information on the air conditioner 16 received in step S103 into the operation information on the air conditioner 16 in a format that can be transmitted/received between the communication module 60 and the home automation server 2, and transmits the operation information on the air conditioner 16 in the format that can be transmitted/received between the communication module 60 and the home automation server 2 to the home automation server 2 via the router 20 and the Internet 4, whereby the home automation server 2 receives the operation information on the air conditioner 16 being transmitted (step S104).

In FIG. 6, the electric utility server 3 first transmits the command for the energy saving control to the home automation server 2 via the Internet 4, and the home automation server 2 receives the command for the energy saving control being transmitted (step S201).

Next, the home automation server 2 transmits the command for the energy saving control received in step S201 to the communication module 60 via the Internet 4 and the router 20, and the communication module 60 receives the command for the energy saving control being transmitted (step S202).

Next, the communication module 60 converts the command for the energy saving control received in step S202 into the command for the energy saving control in the format conforming to the ANSI/CEA-2045 standard, and transmits the command for the energy saving control in the format conforming to the ANSI/CEA-2045 standard to the interface device 40, whereby the home automation communication unit 43 of the interface device 40 receives the command for the energy saving control being transmitted (step S203).

Next, the conversion unit 45 of the interface device 40 converts the command for the energy saving control that is received by the home automation communication unit 43 in step S203 and is in the format conforming to the ANSI/CEA-2045 standard, into the command for the energy saving control in the format conforming to the communication protocol of the air conditioner 16 (step S204). In step S204, the conversion unit 45 of the interface device 40 accumulates the command for the energy saving control received by the home automation communication unit 43 in step S203 into the database 47. In step S204, as illustrated in FIG. 7, the conversion unit uses the database 47 to convert the command for the energy saving control in the format conforming to the ANSI/CEA-2045 standard into the command for the energy saving control in the format conforming to the communication protocol of the air conditioner 16.

Next, the air conditioner communication unit 42 of the interface device 40 transmits, to the air conditioner 16, the command for the energy saving control in the format conforming to the communication protocol of the air conditioner 16 as obtained by the conversion in step S204, and the air conditioner 16 receives the command for the energy saving control being transmitted (step S205).

According to the present embodiment, the interface device 40 converts the operation information of the air conditioner 16 that is transmitted from the air conditioner 16 and is in the format conforming to the communication protocol of the air conditioner 16, into the operation information on the air conditioner 16 in the format conforming to the ANSI/CEA-2045 standard. Moreover, the interface device 40 converts the command for the energy saving control that is transmitted from the home automation server 2 and is in the format conforming to the ANSI/CEA-2045 standard, into the command for the energy saving control in the format conforming to the communication protocol of the air conditioner 16. The interface device 40 thus allows the air conditioner 16 not compliant with the ANSI/CEA-2045 standard to be connected to the home network 1. Even in a case where a user owns a household appliance that is not compliant with the ANSI/CEA-2045 standard, the household appliance not compliant with the ANSI/CEA-2045 standard can be connected to the home network 1. This eliminates the need for replacing the household appliance owned by the user with a household appliance compliant with the ANSI/CEA-2045 standard, thereby making it easier for the user to construct the home network system and at the same time increasing user convenience because the user has a wider range of selection of home appliances.

In the present embodiment, when the interface device 40 transmits the command for the energy saving control to the air conditioner 16, the energy saving management unit 46 of the interface device 40 calculates the value of the set temperature of the air conditioner 16 at the time of the energy saving control by using the user-set value stored in the storage 44 and the value of the set temperature of the air conditioner 16 accumulated in the database 47. The value of the set temperature of the air conditioner 16 calculated by the energy saving management unit 46 is accumulated in the database 47 and transmitted to the air conditioner 16 via the air conditioner communication unit 42. As a result, the energy saving control of the air conditioner 16 according to the user setting is implemented.

### Second Embodiment

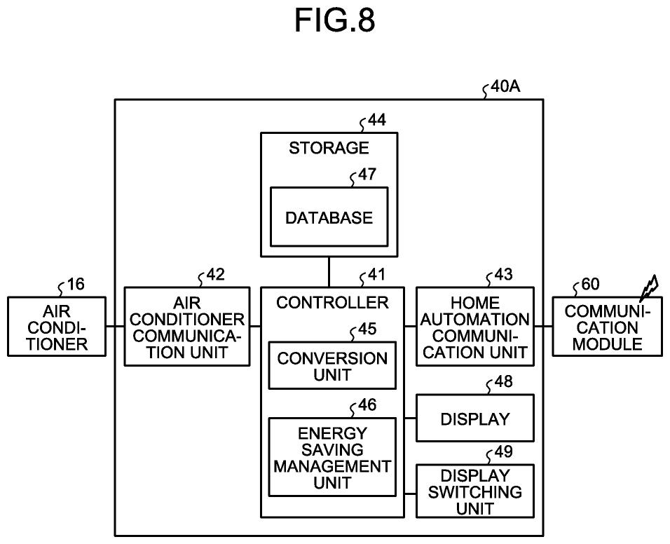

Next, an interface device according to a second embodiment of the present invention will be described. FIG. 8 is a diagram illustrating an example of the functional configuration of an interface device according to the second embodiment of the present invention. An interface device 40A according to the second embodiment of the present invention is different from that of the first embodiment in that a display 48 and a display switching unit 49 are included. Configurations and functions different from those of the first embodiment will be described while omitting the description of configurations and functions overlapping with those of the first embodiment.

As illustrated in FIG. 8, the interface device 40A includes the display 48 and the display switching unit 49.

The display 48 includes a light emitting element such as a light emitting diode (LED). The display 48 displays a status of implementation of the energy saving control of the air conditioner 16. When the energy saving control of the air conditioner 16 is being implemented, the display 48 displays that the energy saving control of the air conditioner 16 is being implemented by turning on or blinking the LED, for example. The display 48 can display a state of communication between the air conditioner 16 and the interface device 40A. When an error has occurred in the communication between the air conditioner 16 and the interface device 40A, the display 48 can display that the error has occurred in the communication between the air conditioner 16 and the interface device 40A by turning on or blinking the LED, for example. The display 48 can also display a communication state between the communication module 60 and the interface device 40A.

The display switching unit 49 includes a switch such as a Dual In-line Package switch (DipSW). The display switching unit 49 can stop the displaying the status of implementation of the energy saving control performed by the air conditioner 16, on the display 48. The display switching unit 49 can switch the display on the display 48. For example, the display switching unit 49 can switch the display on the display 48 from the status of implementation of the energy saving control of the air conditioner 16 to the communication state between the air conditioner 16 and the interface device 40A.

According to the present embodiment, the display 48 displays the status of implementation of the energy saving control of the air conditioner 16. As a result, a user can visually check that the energy saving control of the air conditioner 16 is implemented.

According to the present embodiment, the display switching unit 49 can stop the displaying the status of implementation of the energy saving control of the air conditioner 16 on the display 48. This allows a user who feels discomfort with the LED being lit or blinking to stop the LED from being lit or blinking especially at night.

### Third Embodiment

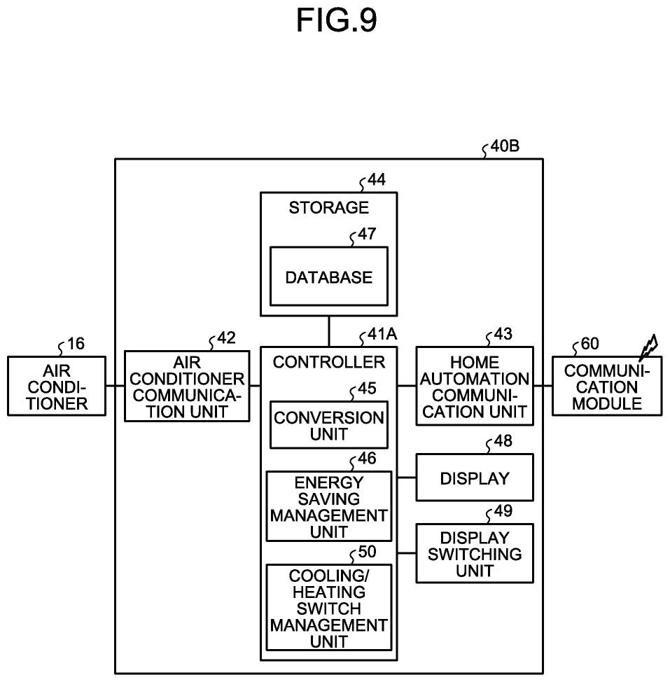

Next, an interface device according to a third embodiment of the present invention will be described. FIG. 9 is a diagram illustrating an example of the functional configuration of an interface device according to the third embodiment of the present invention. An interface device 40B according to the third embodiment of the present invention is different from that of the first and second embodiments in that a controller 41A includes a cooling/heating switch management unit 50. Configurations and functions different from those of the first and second embodiments will be described while omitting the description of configurations and functions overlapping with those of the first and second embodiments.

As illustrated in FIG. 9, the controller 41A includes the cooling/heating switch management unit 50. The cooling/heating switch management unit 50 manages switching between cooling and heating which are the operating modes of the air conditioner 16. The cooling/heating switch management unit 50 can transmit a control command for setting the operating mode of the air conditioner 16 to heating and setting the set temperature thereof to a heating set temperature, to the air conditioner 16 via the air conditioner communication unit 42. The cooling/heating switch management unit 50 can transmit a control command for setting the operating mode of the air conditioner 16 to cooling and setting the set temperature thereof to a cooling set temperature, to the air conditioner 16 via the air conditioner communication unit 42.

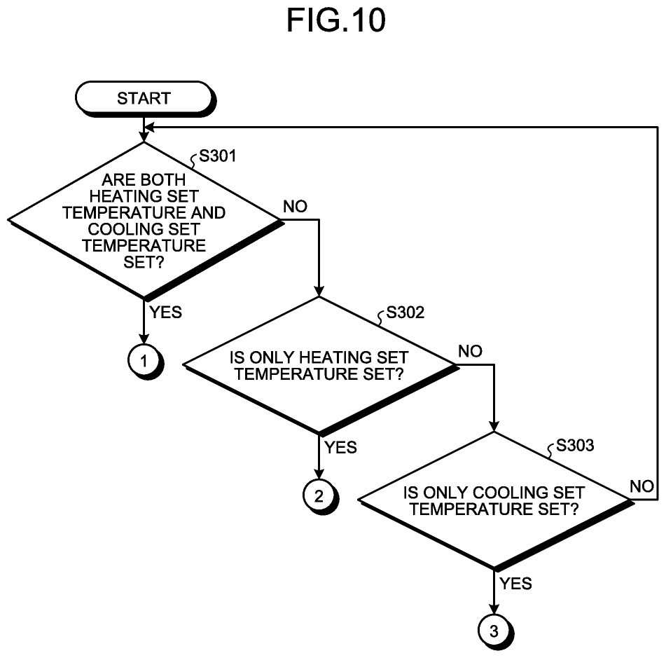

Next, cooling/heating switch process executed by the cooling/heating switch management unit 50 of the interface device 40B in FIG. 9 will be described. FIGS. 10 to 13 are flowcharts of the cooling/heating switch process executed by the cooling/heating switch management unit 50 of the interface device 40B in FIG. 9.

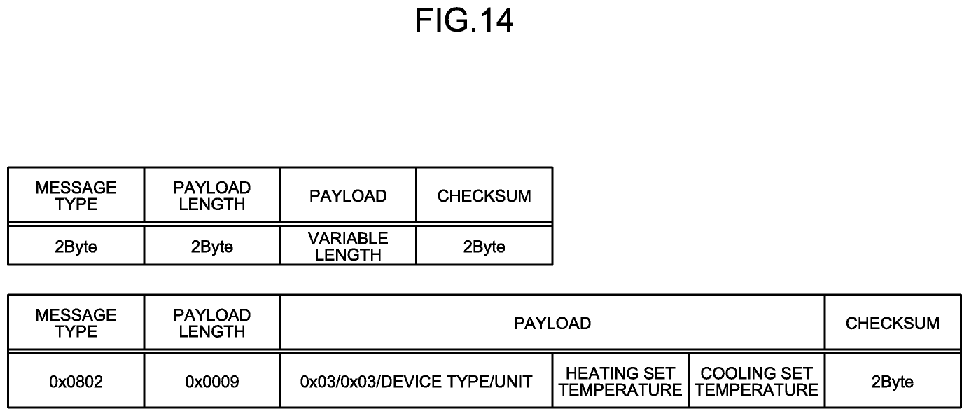

First, as illustrated in FIG. 10, the cooling/heating switch management unit 50 of the interface device 40B refers to information on the set temperature of the air conditioner 16 saved in the database 47 and determines, by the home automation server 2, whether or not both the heating set temperature and the cooling set temperature are set (step S301). In the present embodiment, the information on the set temperature of the air conditioner 16 is transmitted from the home automation server 2. FIG. 14 is a diagram for explaining an example of the information on the set temperature of the air conditioner 16 transmitted from the home automation server 2 in the third embodiment. The information on the set temperature of the air conditioner 16 transmitted from the home automation server 2 is saved in the database 47. The information on the set temperature of the air conditioner 16 is transmitted from the home automation server 2 in the present embodiment, but may be transmitted from the operation terminal of the air conditioner 16 and received by the interface device 40B.

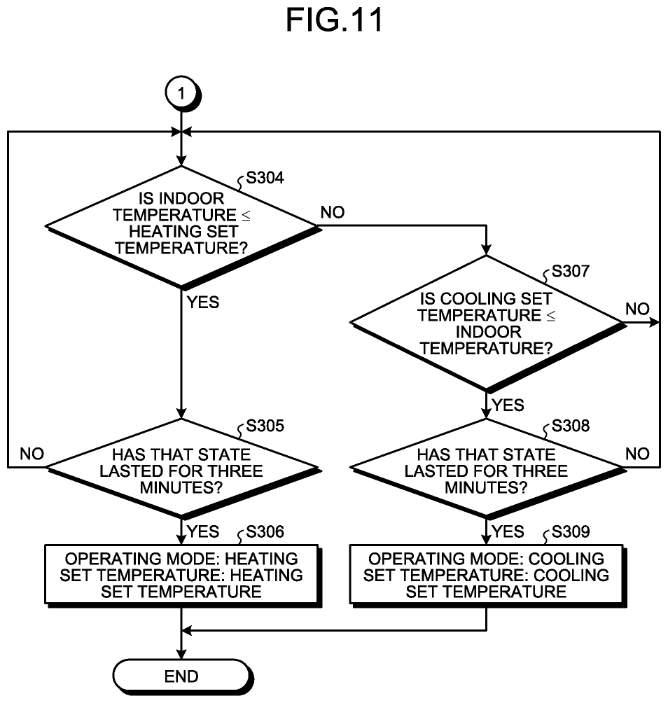

If it is determined in step S301 that both the heating set temperature and the cooling set temperature are set by the home automation server 2 (Yes in step S301), the process proceeds to step S304 in FIG. 11.

If it is determined in step S301 that not both of the heating set temperature and the cooling set temperature are set by the home automation server 2 (No in step S301), the heating/cooling switch management unit determines whether or not only the heating set temperature is set by the home automation server 2 (step S302).

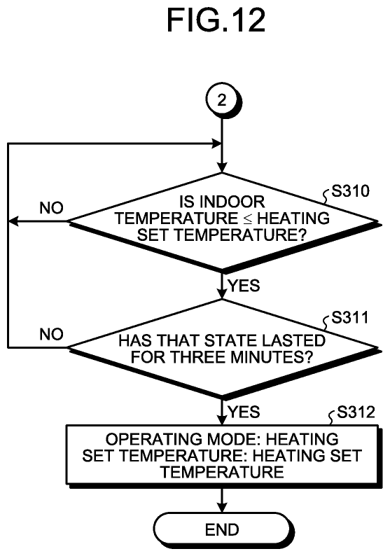

If it is determined in step S302 that only the heating set temperature is set by the home automation server 2 (Yes in step S302), the process proceeds to step S310 in FIG. 12.

If it is determined in step S302 that not the heating set temperature alone is set by the home automation server 2 (No in step S302), the heating/cooling switch management unit determines whether or not only the cooling set temperature is set by the home automation server 2 (step S303).

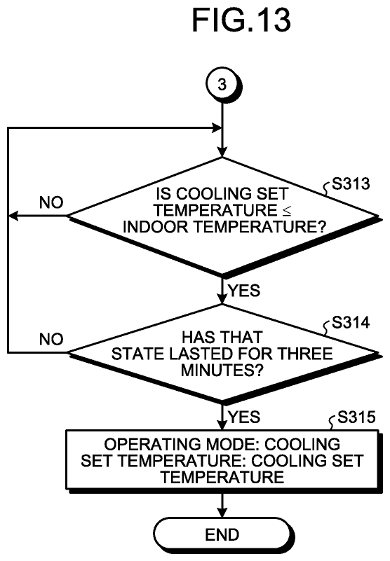

If it is determined in step S303 that only the cooling set temperature is set by the home automation server 2 (Yes in step S303), the process proceeds to step S313 in FIG. 13.

If it is determined in step S303 that not the cooling set temperature alone is set by the home automation server 2 (No in step S303), the process returns to step S301.

Proceeding to FIG. 11, in step S304, the cooling/heating switch management unit 50 of the interface device 40B determines whether or not the temperature of a room in which the air conditioner 16 is installed is lower than or equal to the heating set temperature.

If it is determined in step S304 that the temperature of the room in which the air conditioner 16 is installed is lower than or equal to the heating set temperature (Yes in step S304), the cooling/heating switch management unit 50 of the interface device 40B determines whether or not the temperature of the room in which the air conditioner 16 is installed has been lower than or equal to the heating set temperature for the duration of three minutes (step S305).

If it is determined in step S305 that the temperature of the room in which the air conditioner 16 is installed has not been lower than or equal to the heating set temperature for the duration of three minutes (No in step S305), the process returns to step S304.

If it is determined in step S305 that the temperature of the room in which the air conditioner 16 is installed has been lower than or equal to the heating set temperature for the duration of three minutes (Yes in step S305), the cooling/heating switch management unit 50 of the interface device 40B transmits a control command for setting the operating mode of the air conditioner 16 to heating and setting the set temperature to the heating set temperature, to the air conditioner 16 via the air conditioner communication unit 42 (step S306), and then ends the present process. For example, in step S306, when the temperature of the room has been lower than or equal to 20° C. for the duration of three minutes with the heating set temperature set to 20° C., the cooling/heating switch management unit 50 of the interface device 40B transmits a control command for setting the operating mode of the air conditioner 16 to heating and setting the set temperature to 20° C., to the air conditioner 16.

If it is determined in step S304 that the temperature of the room in which the air conditioner 16 is installed is not lower than or equal to the heating set temperature (No in step S304), the cooling/heating switch management unit 50 of the interface device 40B determines whether or not the temperature of the room in which the air conditioner 16 is installed is higher than or equal to the cooling set temperature (step S307).

If it is determined in step S307 that the temperature of the room in which the air conditioner 16 is installed is not higher than or equal to the cooling set temperature (No in step S307), the process returns to step S304.

If it is determined in step S307 that the temperature of the room in which the air conditioner 16 is installed is higher than or equal to the cooling set temperature (Yes in step S307), the cooling/heating switch management unit 50 of the interface device 40B determines whether or not the temperature of the room in which the air conditioner 16 is installed has been higher than or equal to the cooling set temperature for the duration of three minutes (step S308).

If it is determined in step S308 that the temperature of the room in which the air conditioner 16 is installed has not been higher than or equal to the cooling set temperature for the duration of three minutes (No in step S308), the process returns to step S304.

If it is determined in step S308 that the temperature of the room in which the air conditioner 16 is installed has been higher than or equal to the cooling set temperature for the duration of three minutes (Yes in step S308), the cooling/heating switch management unit 50 of the interface device 40B transmits a control command for setting the operating mode of the air conditioner 16 to cooling and setting the set temperature to the cooling set temperature, to the air conditioner 16 via the air conditioner communication unit 42 (step S309), and then ends the present process. For example, in step S309, when the temperature of the room has been higher than or equal to 27° C. for the duration of three minutes with the cooling set temperature set to 27° C., the cooling/heating switch management unit 50 of the interface device 40B transmits a control command for setting the operating mode of the air conditioner 16 to cooling and setting the set temperature to 27° C., to the air conditioner 16.

Proceeding to FIG. 12, in step S310, the cooling/heating switch management unit 50 of the interface device 40B determines whether or not the temperature of the room in which the air conditioner 16 is installed is lower than or equal to the heating set temperature.

If it is determined in step S310 that the temperature of the room in which the air conditioner 16 is installed is not lower than or equal to the heating set temperature (No in step S310), the process returns to step S310.

If it is determined in step S310 that the temperature of the room in which the air conditioner 16 is installed is lower than or equal to the heating set temperature (Yes in step S310), the cooling/heating switch management unit 50 of the interface device 40B determines whether or not the temperature of the room in which the air conditioner 16 is installed has been lower than or equal to the heating set temperature for the duration of three minutes (step S311).

If it is determined in step S311 that the temperature of the room in which the air conditioner 16 is installed has not been lower than or equal to the heating set temperature for the duration of three minutes (No in step S311), the process returns to step S310.

If it is determined in step S311 that the temperature of the room in which the air conditioner 16 is installed has been lower than or equal to the heating set temperature for the duration of three minutes (Yes in step S311), the cooling/heating switch management unit 50 of the interface device 40B transmits a control command for setting the operating mode of the air conditioner 16 to heating and setting the set temperature to the heating set temperature, to the air conditioner 16 via the air conditioner communication unit 42 (step S312), and then ends the present process.

Proceeding to FIG. 13, in step S313, the cooling/heating switch management unit 50 of the interface device 40B determines whether or not the temperature of the room in which the air conditioner 16 is installed is higher than or equal to the cooling set temperature.

If it is determined in step S313 that the temperature of the room in which the air conditioner 16 is installed is not higher than or equal to the cooling set temperature (No in step S313), the process returns to step S313.

If it is determined in step S313 that the temperature of the room in which the air conditioner 16 is installed is higher than or equal to the cooling set temperature (Yes in step S313), the cooling/heating switch management unit 50 of the interface device 40B determines whether or not the temperature of the room in which the air conditioner 16 is installed has been higher than or equal to the cooling set temperature for the duration of three minutes (step S314).

If it is determined in step S314 that the temperature of the room in which the air conditioner 16 is installed has not been higher than or equal to the cooling set temperature for the duration of three minutes (No in step S314), the process returns to step S313.

If it is determined in step S314 that the temperature of the room in which the air conditioner 16 is installed has been higher than or equal to the cooling set temperature for the duration of three minutes (Yes in step S314), the cooling/heating switch management unit 50 of the interface device 40B transmits a control command for setting the operating mode of the air conditioner 16 to cooling and setting the set temperature to the cooling set temperature, to the air conditioner 16 via the air conditioner communication unit 42 (step S315), and then ends the present process.

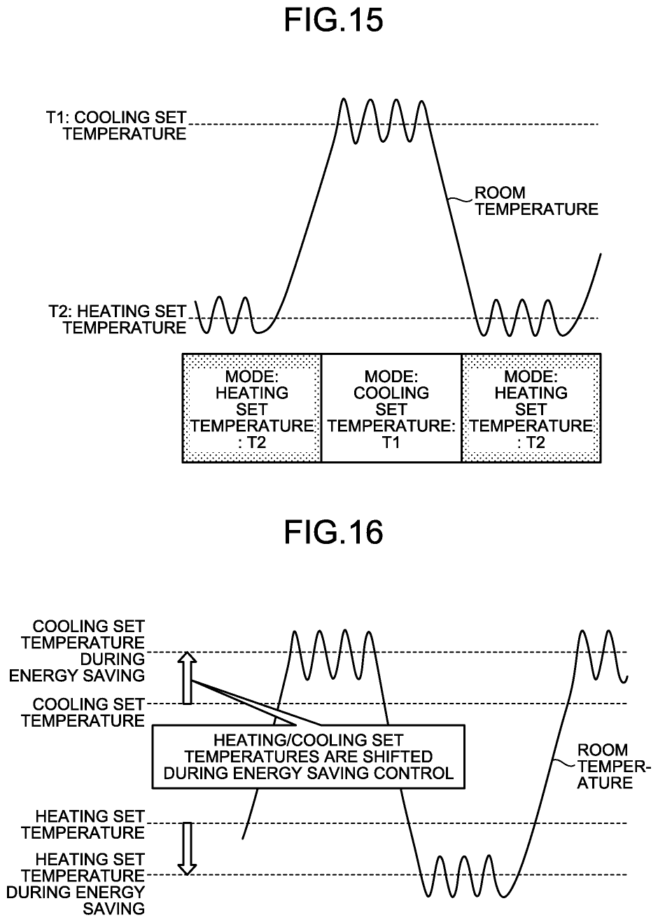

According to the cooling/heating switch process of FIGS. 10 to 13, if the temperature of the room in which the air conditioner 16 is installed has been lower than or equal to the heating set temperature for the duration of three minutes (Yes in step S305), the control command for setting the operating mode of the air conditioner 16 to heating and setting the set temperature to the heating set temperature, is transmitted to the air conditioner 16. If the temperature of the room in which the air conditioner 16 is installed has been higher than or equal to the cooling set temperature for the duration of three minutes (Yes in step S308), the control command for setting the operating mode of the air conditioner 16 to cooling and setting the set temperature to the cooling set temperature, is transmitted to the air conditioner 16. As a result, the temperature of the room in which the air conditioner 16 is installed can be kept within a certain range as illustrated in FIG. 15, so that a desire of a user to keep the temperature of the room within a certain range can be satisfied and that user comfort can be improved.

According to the cooling/heating switch process of FIGS. 10 to 13, even in the case where the database 47 saves information on either the heating set temperature or the cooling set temperature, the operating mode of the air conditioner 16 can be changed in accordance with a change in the temperature of the room. This can increase the convenience of a user who wishes to set only one of the heating set temperature and the cooling set temperature to the air conditioner 16.

In the present embodiment, three minutes is set as the reference duration in determining the duration of the state where the temperature of the room in which the air conditioner 16 is installed is lower than or equal to the heating set temperature and the duration of the state where the temperature of the room in which the air conditioner 16 is installed is higher than or equal to the cooling set temperature. However, the duration is not limited to three minutes. The duration may be changeable by the operation terminal such as the smartphone 30 or a DIP switch.

In the present embodiment, the interface device 40B may directly transmit the information on the set temperature of the air conditioner 16 received from the home automation server 2 to the air conditioner 16 via the air conditioner communication unit 42. In this case, the air conditioner 16 needs to be able to interpret the heating set temperature and the cooling set temperature by itself and to switch the operating mode to heating or cooling depending on the value of the heating set temperature or the cooling set temperature being set. The interface device 40B also needs to be able to allocate the heating set temperature and the cooling set temperature in the information to be transmitted to the air conditioner 16. Whether or not the interface device 40B directly transmits the information on the set temperature of the air conditioner 16 received from the home automation server 2 to the air conditioner 16, may be determined on the basis of model information received from the air conditioner 16 or by a user using the DIP switch included in the interface device 40B.

In the present embodiment, the cooling/heating switch control of the air conditioner 16 may be performed during the energy saving control of the air conditioner 16. In this case, as illustrated in FIG. 16, the range of the temperature of the room is increased by shifting the value of each of the cooling set temperature and the heating set temperature during the energy saving control. Thus, in the case of cooling, for example, the cooling operation is performed at a higher temperature which enables the energy saving control. A user can use the operation terminal such as the smartphone 30 and set an arbitrary value by which the value of each of the heating set temperature and the cooling set temperature is shifted during the energy saving control.

In the present embodiment, the energy saving control and the cooling/heating switch control are performed in coordination with each other so that the energy saving control with improved user comfort can be achieved by shifting the value of the heating set temperature and the value of the cooling set temperature by the arbitrary value that is set by the user during the energy saving control.

The configuration described in the above embodiment merely shows an example of the content of the present invention, and can thus be combined with another known technique or partially omitted and modified without departing from the scope of the present invention.

1. An interface device connected to a device not compliant with a communication standard and connected to a communication module that is connected to a network, the interface device comprising:
a processor; and
a memory to store a program which, when executed by the processor, performs processes of:
transmitting and receiving information in a format conforming to a communication protocol used among a plurality of the devices, to and from the device;
transmitting and receiving information in a format conforming to the communication standard, to and from the communication module; and
converting the information that is received from the device and is in the format conforming to the communication protocol used among the plurality of the devices, into information in the format conforming to the communication standard, and converting the information that is received and is in the format conforming to the communication standard, into information in the format conforming to the communication protocol used among the plurality of the devices.

2. The interface device according to claim 1, wherein the communication standard is an American National Standard Institute (ANSI)/Consumer Electronics Association (CEA)-2045 standard, and the communication module is a Universal Communication Module (UCM).

3. The interface device according to claim 1, wherein the processor further manages energy saving control that reduces power consumption of the device.

4. The interface device according to claim 3, wherein the processor further displays a status of implementation of the energy saving control that reduces the power consumption of the device.

5. The interface device according to claim 4, wherein the processor stops the displaying, on the display, the status of implementation of the energy saving control that reduces the power consumption of the device.

6. The interface device according to claim 1, wherein
the device is an air conditioner, and
the processor further manages switching between cooling and heating that are operating modes of the air conditioner.

7. The interface device according to claim 6, wherein the processor further manages energy saving control that reduces power consumption of the air conditioner.

8. The interface device according to claim 2, wherein the processor further manages energy saving control that reduces power consumption of the device.

9. The interface device according to claim 8, wherein the processor further displays a status of implementation of the energy saving control that reduces the power consumption of the device.

10. The interface device according to claim 9, wherein the processor stops the displaying, on the display, the status of implementation of the energy saving control that reduces the power consumption of the device.
